(19) United States
(12) Patent Application Publication
(10) Pub. No.: US 2026/0169535 A1
(43) Pub. Date: Jun. 18, 2026

(54) BACK POWER PROTECTION OF INPUT/OUTPUT (I/O) PADS

(71) Applicant: QUALCOMM Incorporated, San Diego, CA (US)

(72) Inventors: Shruti HANUMANTHAIAH, Bangalore (IN); Anandu MANOHARAN, Idukki (IN); Surya Chaitanya CHATRATI, Hyderabad (IN); Chiew-Guan TAN, San Diego, CA (US)

(21) Appl. No.: 18/984,752

(22) Filed: Dec. 17, 2024

(51) Int. Cl. G06F 1/26; G06F 1/30; G06F 15/78

(52) U.S. Cl. CPC G06F 1/266; G06F 1/30; G06F 15/7807

(57) ABSTRACT

A first system-on-a-chip (SoC) device includes a first set of input/output (I/O) pads coupling the first SoC device to a second SoC device. The first set of I/O pads is sourced with an always on power supply. The device also includes a second set of I/O pads coupling the first SoC device to a non-SoC device.

### FIELD OF THE DISCLOSURE

The present disclosure relates generally to computing devices and more specifically to back power protection of input/output (I/O) pads in power optimized devices, such as augmented reality (AR) glasses.

### BACKGROUND

Mobile or portable computing devices include mobile phones, laptop, palmtop and tablet computers, portable digital assistants (PDAs), portable game consoles, augmented reality (AR)/virtual reality (VR)/mixed reality (MR) wearable devices, and other portable electronic devices. Mobile computing devices are comprised of many electrical components that consume power. The components (or compute devices) may include system-on-a-chip (SoC) devices, graphics processing unit (GPU) devices, neural processing unit (NPU) devices, digital signal processors (DSPs), and modems, among others.

Augmented reality (AR) merges the real world with virtual objects to support realistic, intelligent, and personalized experiences. Conventional augmented reality applications provide a live view of a real world environment whose elements may be augmented by computer-generated sensory input such as video, sound, graphics, or global positioning system (GPS) data. With such applications, a view of reality may be modified by a computing device, to enhance a user's perception of reality and provide more information about the user's environment. Virtual reality (VR) simulates physical presence in real or imagined worlds, and enables the user to interact in that world. Realizing AR and VR requires the next level of processing within the power envelope of a wearable device, such as eyeglasses.

### SUMMARY

Aspects of the present disclosure are directed to a first system-on-a-chip (SoC) device. The device includes a first set of input/output (I/O) pads coupling the first SoC device to a second SoC device. The first set of I/O pads are sourced with an always on power supply. The device also includes a second set of I/O pads coupling the first SoC device to a non-SoC device.

Other aspects of the present disclosure are directed to a first system-on-a-chip (SoC) device. The device includes first means for coupling the first SoC device to a second SoC device, sourced with an always on power supply. The device also includes second means for coupling the first SoC device to a non-SoC device.

In other aspects of the present disclosure, a method for operating a system on chip (SoC) device includes sourcing a first set of input/output (I/O) pads with an always on power supply. The first set of I/O pads couples the first SoC device to a second SoC device. The method also includes coupling a second number of I/O pads between the first SoC device and a non-SoC device.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The details of one or more examples of the disclosure are set forth in the accompanying drawings and the description below. Other features, objects, and advantages of the disclosure will be apparent from the description and drawings, and from the claims.

FIG. 1 illustrates an example implementation of a system-on-a-chip (SoC).

FIG. 2 is a block diagram that illustrates an example content generation and coding system to implement extended reality (XR) or virtual reality (VR) applications, in accordance with various aspects of the present disclosure.

FIG. 3 is a block diagram illustrating augmented reality or virtual reality subsystems, according to various aspects of the present disclosure.

FIG. 4 is a diagram illustrating locations of components in a wearable device with an eyeglasses form factor, in accordance with various aspects of the present disclosure.

FIG. 5 is a block diagram illustrating a dual system-on-a-chip (SoC) configuration for an extended reality (XR) or augmented reality (AR) device, in accordance with various aspects of the present disclosure.

FIG. 6 is a block diagram illustrating always on input/output (I/O) pads, in accordance with various aspects of the present disclosure.

FIG. 7 is a circuit diagram illustrating power on checker (POC) logic, in accordance with various aspects of the present disclosure.

FIG. 8 is a truth table for the power on checker (POC) logic of FIG. 7, in accordance with various aspects of the present disclosure.

FIG. 9 is a block diagram illustrating multiple I/O pad groups and power sources, in accordance with various aspects of the present disclosure.

FIG. 10 is a block diagram illustrating different options for powering always on I/O pads, in accordance with various aspects of the present disclosure.

FIG. 11 is a flowchart illustrating operation of always on I/O pads, according to various aspects of the present disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings one skilled in the art should appreciate that the scope of this disclosure is intended to cover any aspect of the systems, apparatuses, computer program products, and methods disclosed, whether implemented independently of, or combined with, other aspects of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. Any aspect disclosed may be embodied by one or more elements of a claim.

Although various aspects are described, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different computing device technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, system-on-a-chips (SoCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described, one or more techniques may refer to an application (e.g., software) being configured to perform one or more functions. In such examples, the application may be stored on a memory (e.g., on-chip memory of a processor, system memory, or any other memory). Hardware described, such as a processor may be configured to execute the application. For example, the application may be described as including code that, when executed by the hardware, causes the hardware to perform one or more techniques described. As an example, the hardware may access the code from a memory and executed the code accessed from the memory to perform one or more techniques described. In some examples, components are identified in this disclosure. In such examples, the components may be hardware, software, or a combination thereof. The components may be separate components or sub-components of a single component.

Accordingly, in one or more examples described, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

For a mobile device, such as a mobile telephone, a single printed circuit board (PCB) may support multiple components including a CPU, GPU, DSP, etc. For an augmented reality (AR) or virtual reality (VR) device, the components may be located on different PCBs due to the form factor of the AR or VR device. For example, the AR or VR device may be in the form of eyeglasses. In an example implementation, a main SoC (also referred to as a main processor) and a main power management integrated circuit (PMIC) may reside on a first PCB in one of the arms of the eyeglasses. A camera and sensor co-processor and associated PMIC may reside on a second PCB near the bridge of the eyeglasses. A connectivity processor and associated PMIC may reside on a third PCB on the other arm of the eyeglasses.

Multi-chip designs are becoming more relevant in extended reality (XR) devices, automotive devices, wearable devices, general compute devices with a main SoC and an input/output (I/O) hub, and modems having an application processor and modem fusion. In muti-chip designs, back powering can arise due to different power states of chips that are interconnected through one or more chip-to-chip interfaces. This back powering occurs when one chip with interfaces is in a power OFF state whereas the other chip is in a power ON state. The powered chip can drive current into the chip-to-chip interface, potentially damaging the I/O pads and internal infrastructure of the chip in the OFF state. If this scenario occurs frequently, the back powered I/O pads become electrically stressed and eventually damaged, leading to system failure or a damaged end product.

Aspects of the present disclosure power the I/O pads that need to be protected (e.g., the back powered I/O pads) with always on (AON) power. Because the I/O pads are always powered, irrespective of whether the chips on both sides are ON or OFF, the I/O pads remain protected from any back powering from the other side.

The I/O pads should be always on, even when core logic power rails (CX) and memory power rails (MX) are down. The always on power supply for the I/O pads, however, violates the fundamental power on (PON) sequence for the CX, MX, and pad power rails (PX). That is, the power on sequence specifies that the memory power rail should power on before the core logic power rail, which should power on before the pad power rail (e.g., MX>CX>PX).

Aspects of the present disclosure overcome this issue by adding a signal, referred to as a power on checker (POC), into the pad. The power on checker signal removes the dependency on the input power domain, e.g., the memory power rail (MX) and the core logic power rail (CX). With the power on checker signal, the I/O pads are powered even when core logic and memory power rails (e.g., CX and MX) of the SoC are down. The POC signal disables both an input receiver of the I/O pads and an output buffer of the I/O pads, thereby protecting the pads.

Particular aspects of the subject matter described in this disclosure can be implemented to realize one or more of the following potential advantages. In some examples, the described techniques, such as providing always on power to I/O pads, reduce current leakage and save bill of material costs, while also saving die area with the smaller pad size. These aspects have applications in any multi-chip system across segments like wearables, modems, compute devices, and Internet-of-things (IOT) devices that use advanced technology nodes.

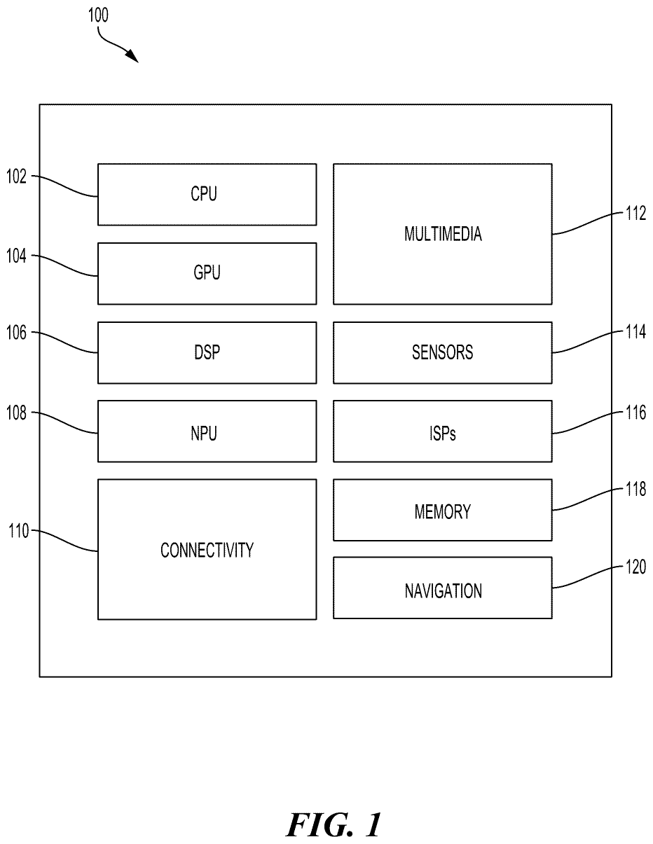

FIG. 1 illustrates an example implementation of a system-on-a-chip (SoC) 100. The host SoC 100 includes processing blocks tailored to specific functions, such as a connectivity block 110. The connectivity block 110 may include fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, extended reality (XR) gaming, artificial networks, and the like. The multi-core CPU 102, the GPU 104, the DSP 106, the NPU 108, and the multi-media engine 112 may be interconnected via input/output (I/O) pads (not shown in FIG. 1). Each processor core of the multi-core CPU 102 may be a reduced instruction set computing (RISC) machine, an advanced RISC machine (ARM), a microprocessor, or some other type of processor. The NPU 108 may be based on an ARM instruction set.

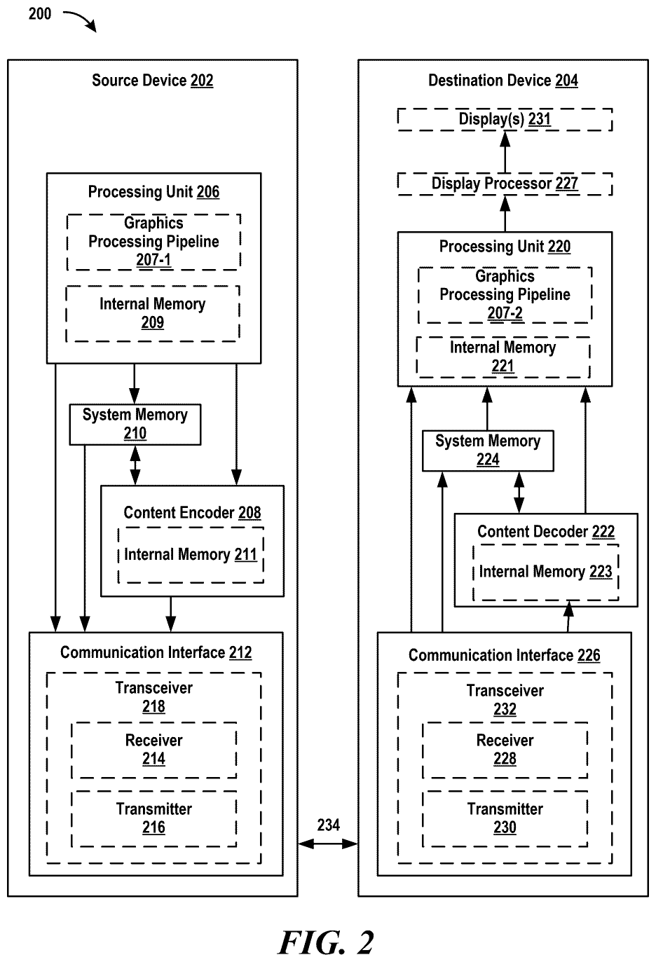

FIG. 2 is a block diagram that illustrates an example extended reality (XR) or virtual reality (VR) system 200 configured to implement extended reality (XR) or VR applications, according to aspects of the present disclosure. The system 200 includes a source device 202 and a destination device 204. In accordance with the techniques described, the source device 202 may be configured to encode, using the content encoder 208, graphical content generated by the processing unit 206 prior to transmission to the destination device 204. The content encoder 208 may be configured to output a bitstream having a bit rate. The processing unit 206 may be configured to control and/or influence the bit rate of the content encoder 208 based on how the processing unit 206 generates graphical content.

The source device 202 may include one or more components (or circuits) for performing various functions described herein. The destination device 204 may include one or more components (or circuits) for performing various functions described. In some examples, one or more components of the source device 202 may be components of a system-on-a-chip (SoC). Similarly, in some examples, one or more components of the destination device 204 may be components of an SoC.

The source device 202 may include one or more components configured to perform one or more techniques of this disclosure. In the example shown, the source device 202 may include a processing unit 206, a content encoder 208, a system memory 210, and a communication interface 212. The processing unit 206 may include an internal memory 209. The processing unit 206 may be configured to perform graphics processing, such as in a graphics processing pipeline 207-1. The content encoder 208 may include an internal memory 211.

Memory external to the processing unit 206 and the content encoder 208, such as system memory 210, may be accessible to the processing unit 206 and the content encoder 208. For example, the processing unit 206 and the content encoder 208 may be configured to read from and/or write to external memory, such as the system memory 210. The processing unit 206 and the content encoder 208 may be communicatively coupled to the system memory 210 over a bus. In some examples, the processing unit 206 and the content encoder 208 may be communicatively coupled to each other over the bus or a different connection.

The content encoder 208 may be configured to receive graphical content from any source, such as the system memory 210 and/or the processing unit 206. The system memory 210 may be configured to store graphical content generated by the processing unit 206. For example, the processing unit 206 may be configured to store graphical content in the system memory 210. The content encoder 208 may be configured to receive graphical content (e.g., from the system memory 210 and/or the processing unit 206) in the form of pixel data. Otherwise described, the content encoder 208 may be configured to receive pixel data of graphical content produced by the processing unit 206. For example, the content encoder 208 may be configured to receive a value for each component (e.g., each color component) of one or more pixels of graphical content. As an example, a pixel in the red, green, blue (RGB) color space may include a first value for the red component, a second value for the green component, and a third value for the blue component.

The internal memory 209, the system memory 210, and/or the internal memory 211 may include one or more volatile or non-volatile memories or storage devices. In some examples, internal memory 209, the system memory 210, and/or the internal memory 211 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 209, the system memory 210, and/or the internal memory 211 may be a non-transitory storage medium according to some examples. The term “non-transitory” may indicate that the storage medium is not embodied in a carrier wave or a propagated signal. However, the term “non-transitory” should not be interpreted to mean that internal memory 209, the system memory 210, and/or the internal memory 211 is non-movable or that its contents are static. As one example, the system memory 210 may be removed from the source device 202 and moved to another device. As another example, the system memory 210 may not be removable from the source device 202.

The processing unit 206 may be a central processing unit (CPU), a graphics processing unit (GPU), a general purpose GPU (GPGPU), or any other processing unit that may be configured to perform graphics processing. In some examples, the processing unit 206 may be integrated into a motherboard of the source device 202. In some examples, the processing unit 206 may be present on a graphics card that is installed in a port in a motherboard of the source device 202, or may be otherwise incorporated within a peripheral device configured to interoperate with the source device 202.

The processing unit 206 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 206 may store instructions for the software in a suitable, non-transitory computer-readable storage medium (e.g., internal memory 209), and may execute the instructions in hardware using one or more processors to perform the techniques of this disclosure. Any of the foregoing (including hardware, software, a combination of hardware and software, etc.) may be considered to be one or more processors.

The content encoder 208 may be any processing unit configured to perform content encoding. In some examples, the content encoder 208 may be integrated into a motherboard of the source device 202. The content encoder 208 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 208 may store instructions for the software in a suitable, non-transitory computer-readable storage medium (e.g., internal memory 211), and may execute the instructions in hardware using one or more processors to perform the techniques of this disclosure. Any of the foregoing (including hardware, software, a combination of hardware and software, etc.) may be considered to be one or more processors.

The communication interface 212 may include a receiver 214 and a transmitter 216. The receiver 214 may be configured to perform any receiving function described with respect to the source device 202. For example, the receiver 214 may be configured to receive information from the destination device 204, which may include a request for content. In some examples, in response to receiving the request for content, the source device 202 may be configured to perform one or more techniques described, such as produce or otherwise generate graphical content for delivery to the destination device 204. The transmitter 216 may be configured to perform any transmitting function described herein with respect to the source device 202. For example, the transmitter 216 may be configured to transmit encoded content to the destination device 204, such as encoded graphical content produced by the processing unit 206 and the content encoder 208 (e.g., the graphical content is produced by the processing unit 206, which the content encoder 208 receives as input to produce or otherwise generate the encoded graphical content). The receiver 214 and the transmitter 216 may be combined into a transceiver 218. In such examples, the transceiver 218 may be configured to perform any receiving function and/or transmitting function described with respect to the source device 202.

The destination device 204 may include one or more components configured to perform one or more techniques of this disclosure. In the example shown, the destination device 204 may include a processing unit 220, a content decoder 222, a system memory 224, a communication interface 226, and one or more displays 231. Reference to the displays 231 may refer to the one or more displays 231. For example, the displays 231 may include a single display or multiple displays. The displays 231 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 220 may include an internal memory 221. The processing unit 220 may be configured to perform graphics processing, such as in a graphics processing pipeline 207-2. The content decoder 222 may include an internal memory 223. In some examples, the destination device 204 may include a display processor, such as the display processor 227, to perform one or more display processing techniques on one or more frames generated by the processing unit 220 before presentment by the one or more displays 231. The display processor 227 may be configured to perform display processing. For example, the display processor 227 may be configured to perform one or more display processing techniques on one or more frames generated by the processing unit 220. The one or more displays 231 may be configured to display content that was generated using decoded content. For example, the display processor 227 may be configured to process one or more frames generated by the processing unit 220, where the one or more frames are generated by the processing unit 220 by using decoded content that was derived from encoded content received from the source device 202. In turn the display processor 227 may be configured to perform display processing on the one or more frames generated by the processing unit 220. The one or more displays 231 may be configured to display or otherwise present frames processed by the display processor 227. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 220 and the content decoder 222, such as system memory 224, may be accessible to the processing unit 220 and the content decoder 222. For example, the processing unit 220 and the content decoder 222 may be configured to read from and/or write to external memory, such as the system memory 224. The processing unit 220 and the content decoder 222 may be communicatively coupled to the system memory 224 over a bus. In some examples, the processing unit 220 and the content decoder 222 may be communicatively coupled to each other over the bus or a different connection.

The content decoder 222 may be configured to receive graphical content from any source, such as the system memory 224 and/or the communication interface 226. The system memory 224 may be configured to store received encoded graphical content, such as encoded graphical content received from the source device 202. The content decoder 222 may be configured to receive encoded graphical content (e.g., from the system memory 224 and/or the communication interface 226) in the form of encoded pixel data. The content decoder 222 may be configured to decode encoded graphical content.

The internal memory 221, the system memory 224, and/or the internal memory 223 may include one or more volatile or non-volatile memories or storage devices. In some examples, internal memory 221, the system memory 224, and/or the internal memory 223 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 221, the system memory 224, and/or the internal memory 223 may be a non-transitory storage medium according to some examples. The term “non-transitory” may indicate that the storage medium is not embodied in a carrier wave or a propagated signal. However, the term “non-transitory” should not be interpreted to mean that internal memory 221, the system memory 224, and/or the internal memory 223 is non-movable or that its contents are static. As one example, the system memory 224 may be removed from the destination device 204 and moved to another device. As another example, the system memory 224 may not be removable from the destination device 204.

The processing unit 220 may be a central processing unit (CPU), a graphics processing unit (GPU), a general purpose GPU (GPGPU), or any other processing unit that may be configured to perform graphics processing. In some examples, the processing unit 220 may be integrated into a motherboard of the destination device 204. In some examples, the processing unit 220 may be present on a graphics card that is installed in a port in a motherboard of the destination device 204, or may be otherwise incorporated within a peripheral device configured to interoperate with the destination device 204.

The processing unit 220 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 220 may store instructions for the software in a suitable, non-transitory computer-readable storage medium (e.g., internal memory 221), and may execute the instructions in hardware using one or more processors to perform the techniques of this disclosure. Any of the foregoing (including hardware, software, a combination of hardware and software, etc.) may be considered to be one or more processors.

The content decoder 222 may be any processing unit configured to perform content decoding. In some examples, the content decoder 222 may be integrated into a motherboard of the destination device 204. The content decoder 222 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content decoder 222 may store instructions for the software in a suitable, non-transitory computer-readable storage medium (e.g., internal memory 223), and may execute the instructions in hardware using one or more processors to perform the techniques of this disclosure. Any of the foregoing (including hardware, software, a combination of hardware and software, etc.) may be considered to be one or more processors.

The communication interface 226 may include a receiver 228 and a transmitter 230. The receiver 228 may be configured to perform any receiving function described herein with respect to the destination device 204. For example, the receiver 228 may be configured to receive information from the source device 202, which may include encoded content, such as encoded graphical content produced or otherwise generated by the processing unit 206 and the content encoder 208 of the source device 202 (e.g., the graphical content is produced by the processing unit 206, which the content encoder 208 receives as input to produce or otherwise generate the encoded graphical content). As another example, the receiver 228 may be configured to receive position information from the source device 202, which may be encoded or unencoded (e.g., not encoded). In some examples, the destination device 204 may be configured to decode encoded graphical content received from the source device 202 in accordance with the techniques described herein. For example, the content decoder 222 may be configured to decode encoded graphical content to produce or otherwise generate decoded graphical content. The processing unit 220 may be configured to use the decoded graphical content to produce or otherwise generate one or more frames for presentment on the one or more displays 231. The transmitter 230 may be configured to perform any transmitting function described herein with respect to the destination device 204. For example, the transmitter 230 may be configured to transmit information to the source device 202, which may include a request for content. The receiver 228 and the transmitter 230 may be combined into a transceiver 232. In such examples, the transceiver 232 may be configured to perform any receiving function and/or transmitting function described herein with respect to the destination device 204.

The content encoder 208 and the content decoder 222 of XR gaming system 200 represent examples of computing components (e.g., processing units) that may be configured to perform one or more techniques for encoding content and decoding content in accordance with various examples described in this disclosure, respectively. In some examples, the content encoder 208 and the content decoder 222 may be configured to operate in accordance with a content coding standard, such as a video coding standard, a display stream compression standard, or an image compression standard.

As shown in FIG. 2, the source device 202 may be configured to generate encoded content. Accordingly, the source device 202 may be referred to as a content encoding device or a content encoding apparatus. The destination device 204 may be configured to decode the encoded content generated by source device 202. Accordingly, the destination device 204 may be referred to as a content decoding device or a content decoding apparatus. In some examples, the source device 202 and the destination device 204 may be separate devices, as shown. In other examples, source device 202 and destination device 204 may be on or part of the same computing device. In either example, a graphics processing pipeline may be distributed between the two devices. For example, a single graphics processing pipeline may include a plurality of graphics processes. The graphics processing pipeline 207-1 may include one or more graphics processes of the plurality of graphics processes. Similarly, graphics processing pipeline 207-2 may include one or more processes graphics processes of the plurality of graphics processes. In this regard, the graphics processing pipeline 207-1 concatenated or otherwise followed by the graphics processing pipeline 207-2 may result in a full graphics processing pipeline. Otherwise described, the graphics processing pipeline 207-1 may be a partial graphics processing pipeline and the graphics processing pipeline 207-2 may be a partial graphics processing pipeline that, when combined, result in a distributed graphics processing pipeline.

In some examples, a graphics process performed in the graphics processing pipeline 207-1 may not be performed or otherwise repeated in the graphics processing pipeline 207-2. For example, the graphics processing pipeline 207-1 may include receiving first position information corresponding to a first orientation of a device. The graphics processing pipeline 207-1 may also include generating first graphical content based on the first position information. Additionally, the graphics processing pipeline 207-1 may include generating motion information for warping the first graphical content. The graphics processing pipeline 207-1 may further include encoding the first graphical content. Also, the graphics processing pipeline 207-1 may include providing the motion information and the encoded first graphical content. The graphics processing pipeline 207-2 may include providing first position information corresponding to a first orientation of a device. The graphics processing pipeline 207-2 may also include receiving encoded first graphical content generated based on the first position information. Further, the graphics processing pipeline 207-2 may include receiving motion information. The graphics processing pipeline 207-2 may also include decoding the encoded first graphical content to generate decoded first graphical content. Also, the graphics processing pipeline 207-2 may include warping the decoded first graphical content based on the motion information. By distributing the graphics processing pipeline between the source device 202 and the destination device 204, the destination device may be able to, in some examples, present graphical content that it otherwise would not be able to render; and, therefore, could not present. Other example benefits are described throughout this disclosure.

As described, a device, such as the source device 202 and/or the destination device 204, may refer to any device, apparatus, or system configured to perform one or more techniques described. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 202 may be configured to communicate with the destination device 204. For example, destination device 204 may be configured to receive encoded content from the source device 202. In some example, the communication coupling between the source device 202 and the destination device 204 is shown as link 234. Link 234 may comprise any type of medium or device capable of moving the encoded content from source device 202 to the destination device 204.

In the example of FIG. 2, link 234 may comprise a communication medium to enable the source device 202 to transmit encoded content to destination device 204 in real-time. The encoded content may be modulated according to a communication standard, such as a wireless communication protocol, and transmitted to destination device 204. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 202 to the destination device 204. In other examples, link 234 may be a point-to-point connection between source device 202 and destination device 204, such as a wired or wireless display link connection (e.g., a high-definition multimedia interface (HDMI) link, a DisplayPort link, mobile industry processor interface (MIPI) display serial interface (DSI) link, or another link over which encoded content may traverse from the source device 202 to the destination device 204.

In another example, the link 234 may include a storage medium configured to store encoded content generated by the source device 202. In this example, the destination device 204 may be configured to access the storage medium. The storage medium may include a variety of locally-accessed data storage media such as Blu-ray discs, DVDs, CD-ROMs, flash memory, or other suitable digital storage media for storing encoded content.

In another example, the link 234 may include a server or another intermediate storage device configured to store encoded content generated by the source device 202. In this example, the destination device 204 may be configured to access encoded content stored at the server or other intermediate storage device. The server may be a type of server capable of storing encoded content and transmitting the encoded content to the destination device 204.

Devices described may be configured to communicate with each other, such as the source device 202 and the destination device 204. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to multiple client devices. As another example, any device described configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices are inclusive of more than two devices. For example, a first device may communicatively couple with a second device and the first device may communicatively couple with a third device. In such an example, the first device may be a server.

With reference to FIG. 2, the source device 202 may be described as being communicatively coupled to the destination device 204. In some examples, the term “communicatively coupled” may refer to a communication connection, which may be direct or indirect. The link 234 may, in some examples, represent a communication coupling between the source device 202 and the destination device 204. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 202, may be configured to unicast, broadcast, multicast, or otherwise transmit information (e.g., encoded content) to one or more other devices (e.g., one or more destination devices, which includes the destination device 204). The destination device 204 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described, such as the source device 202 and the destination device 204, may be configured to operate in accordance with one or more communication protocols. For example, the source device 202 may be configured to communicate with (e.g., receive information from and/or transmit information to) the destination device 204 using one or more communication protocols. In such an example, the source device 202 may be described as communicating with the destination device 204 over a connection. The connection may be compliant or otherwise be in accordance with a communication protocol. Similarly, the destination device 204 may be configured to communicate with (e.g., receive information from and/or transmit information to) the source device 202 using one or more communication protocols. In such an example, the destination device 204 may be described as communicating with the source device 202 over a connection. The connection may be compliant or otherwise be in accordance with a communication protocol.

The term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, 5G, or 6G.

With reference to FIG. 2, the content encoder 208 may be configured to encode graphical content. In some examples, the content encoder 208 may be configured to encode graphical content as one or more video frames of extended reality (XR) or virtual reality (VR) content. When the content encoder 208 encodes content, the content encoder 208 may generate a bitstream. The bitstream may have a bit rate, such as bits/time unit, where time unit is any time unit, such as second or minute. The bitstream may include a sequence of bits that form a coded representation of the graphical content and associated data. To generate the bitstream, the content encoder 208 may be configured to perform encoding operations on pixel data, such as pixel data corresponding to a shaded texture atlas. For example, when the content encoder 208 performs encoding operations on image data (e.g., one or more blocks of a shaded texture atlas) provided as input to the content encoder 208, the content encoder 208 may generate a series of coded images and associated data. The associated data may include a set of coding parameters such as a quantization parameter (QP).

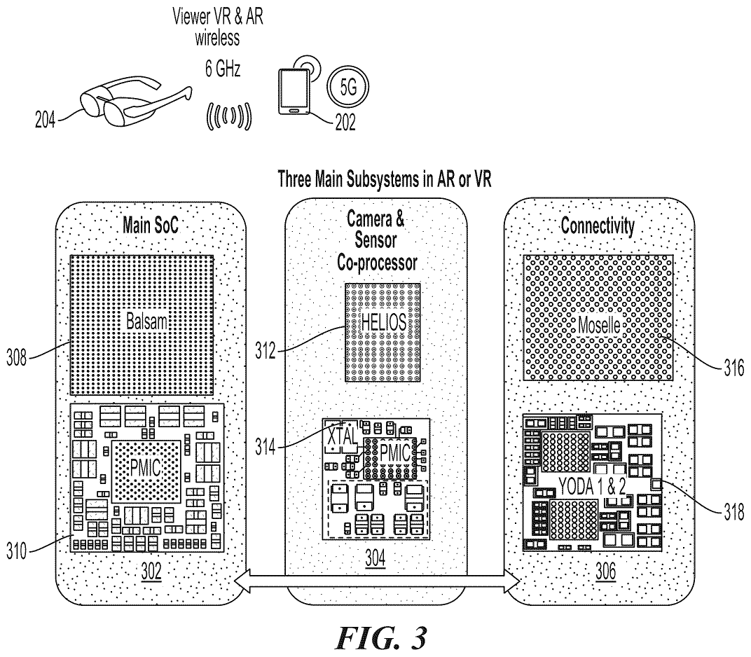

As shown in FIG. 1, a single printed circuit board (PCB) may support multiple components of the SoC 100, including the CPU 102, GPU 104, DSP 106, etc. For an AR or VR device, the components may be located on different PCBs. FIG. 3 is a block diagram illustrating augmented reality or virtual reality subsystems, according to aspects of the present disclosure. As seen in the example of FIG. 3, the destination device 204 may be in the form of eyeglasses and the source device 202 may be in the form of a mobile device. If the destination device 204 has an eyeglasses form factor, the various components may be distributed across multiple PCBs 302, 304, 306 in a multi-PCB architecture. For example, a master or main SoC 308 and a master power management integrated circuit (PMIC) 310 may reside on a first PCB 302, a camera and sensor co-processor 312 and associated PMIC 314 may reside on a second PCB 304, and a connectivity processor 316 and associated PMIC 318 may reside on a third PCB 306.

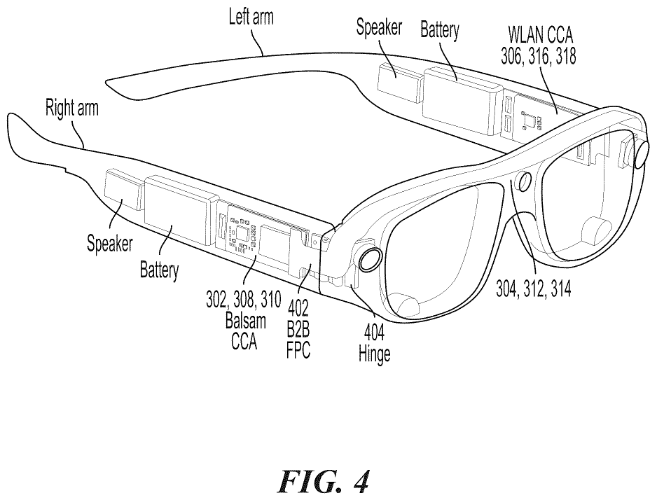

FIG. 4 is a diagram illustrating placement of components in a device with an eyeglasses form factor, in accordance with aspects of the present disclosure. As seen in the example of FIG. 4, the master SoC 308 and master power management IC (PMIC) 310 may reside on the first PCB 302 (also referred to as CCA—circuit card assembly) in one arm of the glasses, the camera and sensor co-processor 312 and associated PMIC 314 may reside on the second PCB 304 on the bridge of the eyeglasses, and the connectivity processor 316 and associated PMIC 318 may reside on the third PCB 306 on another arm of the glasses. Location of batteries and speakers are also shown in FIG. 4. A board-to-board (B2B) flexible printed circuit (FPC) connector 402 couples the first PCB 302, the second PCB 304, and the third PCB 306 across hinges 404 (only one labelled) of the eyeglasses. The augmented reality chip may be referred to as ‘Balsam’ throughout this disclosure.

In muti-chip designs, back powering can arise due to the different power states of chips that are interconnected through a chip-to-chip interface or multiple such interfaces. This back powering occurs when one chip with interfaces is in a power OFF state whereas the other chip is in a power ON state. The powered chip can drive current into the chip-to-chip interface, potentially damaging the input/output (I/O) pads and internal infrastructure of the chip in the OFF state.

Currently, back powering is addressed with back power protection (BPP) pads, which are a special type of I/O pads made of thick oxide coated transistors to handle electrostatic discharge (ESD) events. BPP pads are larger in size compared to other general purpose input/output (GPIO) pads, for example, two to three times larger. Also, the leakage current is higher for BPP pads, for example, increased from 2-3 micro amps (uA) to 40-50 uA for BPP pad leakage.

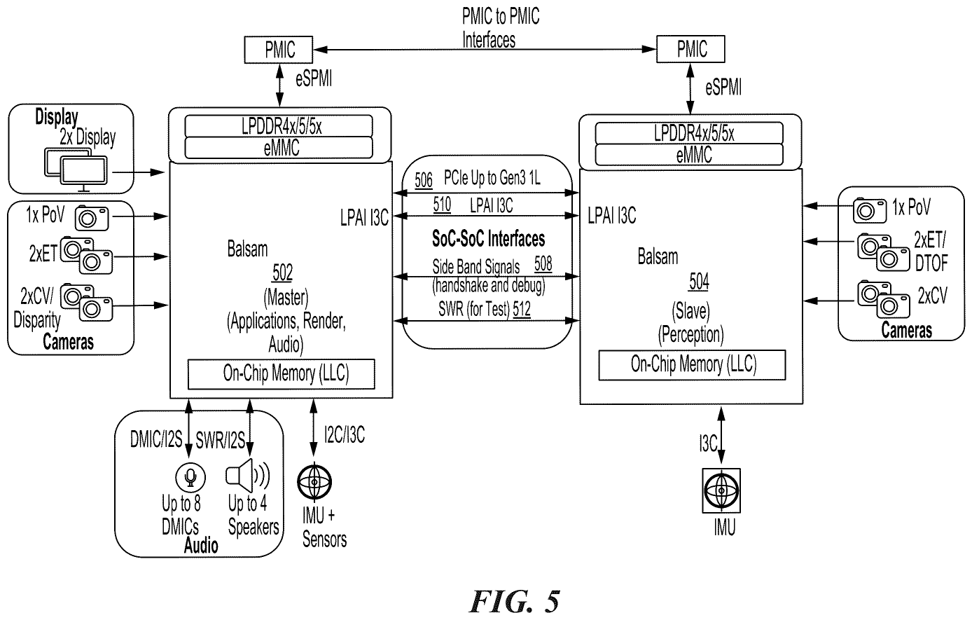

Multi-chip designs are becoming more and more relevant in extended reality (XR) devices, automotive devices, wearable devices, general compute devices with a main SoC and an I/O hub, and modems having an application processor and modem fusion. FIG. 5 is a block diagram illustrating a dual system-on-a-chip (SoC) configuration for an XR or augmented reality (AR) device, in accordance with various aspects of the present disclosure. As seen in the example of FIG. 5, there are many interfaces between a master SoC (e.g., Balsam) 502 and a slave SoC (e.g., Balsam) 504. The interfaces may include a peripheral component interface express (PCIe) data interface 506, a reference clock interface (not shown), a side band interface 508, an improved inter-integrated circuit (I3C) interface 510, and other side band interfaces, for example a soundware (SWR) interface 512, etc.

There are scenarios when the slave SoC 504 is OFF or in a reset state while the master SoC 502 is ON. Software does not have much control on the signals being driven on the peripheral component interconnect express (PCIe) side bands 506, 508 (e.g., PCIe_Clock_Req, Wake_N, and PRST_N). The PCIe_Clk_Req_N signal is a PCIe side band signal with an internal default pullup at both the master SoC 502 and the slave SoC 504. This pullup is always present when the respective SoC 502, 504 is ON. In SoC-to-SoC interconnections, this pullup leads to back powering of the I/O pads on the SoC 504,502 that is OFF.

Even for other signals, the master SoC 502 takes some time (e.g., tens of milliseconds) to know that the slave SoC 504 is in the OFF or reset state. During this interval, the master SoC 502 can drive current into the SoC-to-SoC interfaces 506-512. This scenario leads to back powering the I/O pads on the slave SoC 504. If this scenario occurs frequently, the pads being back powered become electrically stressed and eventually damaged, leading to system failure or a damaged end product.

BPP pads are not feasible for advanced technology nodes based SoCs (e.g., four nanometer (nm) and beyond) because when the technology node shrinks, the availability of thick oxide transistors diminishes. Thus, a system level solution is desired for future advanced technology node chips.

Aspects of the present disclosure power the I/O pads that need to be protected with always on (AON) power. The I/O pads may also be referred to as pads. Because the pads are always powered irrespective of whether the chips on both sides are ON or OFF, the pads remain protected from any back powering from the other side.

In dual SoC (e.g., Balsam) based augmented reality (AR) glasses, the master SoC 502 (e.g., apps processor) can be ON when the slave SoC 504 (e.g., perception processor) is OFF. In this case, the master SoC 502 back powers the slave SoC 504 through SoC-to-SoC interfaces. The slave pads may become damaged. To avoid this, a new system level solution includes always ON power in the slave side that always powers the SoC-to-SoC pads. This always ON power is present as long as the battery is connected, irrespective of the slave power state.

In some implementations, more than one pad group type may be provided when multiple interconnections exist between the two SoCs. For example, in FIG. 5, four different types of interfaces 506-512 are shown between the SoCs 502, 504. In these aspects of the present disclosure, based on functions of the pads and their usage in different configurations, whichever pads need protection against back powering are sourced from the always on power domain. The other pads are powered as part of a regular power on sequence, thus further decreasing the leakage. For example, if the I3C interface 510 does not need back power protection, the pads associated with the I3C interface 510 are not sourced by the always on power domain.

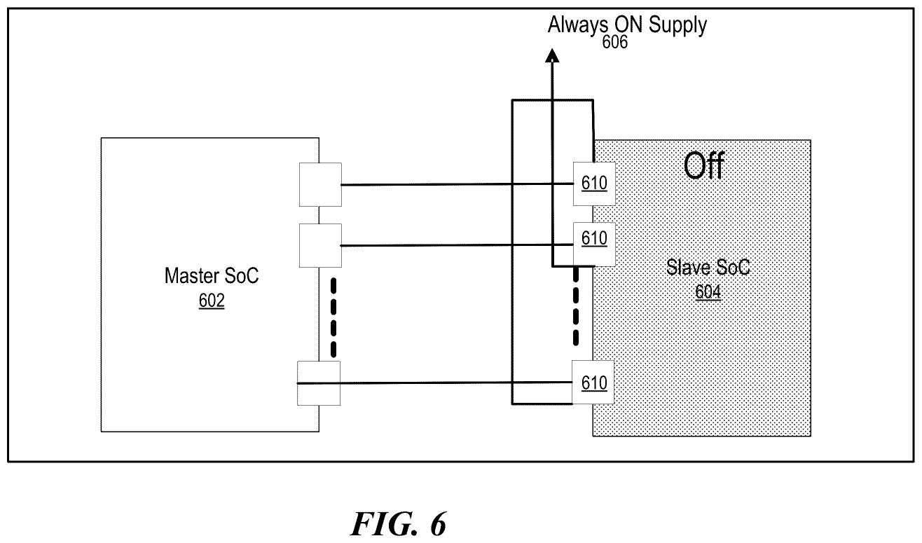

FIG. 6 is a block diagram illustrating always on input/output (I/O) pads, in accordance with various aspects of the present disclosure. In the example of FIG. 6, a master SoC 602 is powered ON and a slave SoC 604 is powered OFF. An always on power supply 606 provides power to I/O pads 610 at the slave SoC 604. The same solution can be extended to master I/O pads as well. If there is a scenario where the slave SoC 604 is ON and the master SoC 602 is OFF, then an always on power supply of the master interfaces ensures that these interfaces on the master side are protected from back powering.

The pads should be always on, even when core logic power rails (CX) and memory power rails (MX) are down. The always on power supply for the pads, however, violates the fundamental power on (PON) sequence for the CX, MX, and pad power rails (PX). That is, the power on sequence specifies that the memory power rail should power on before the core logic power rail, which should power on before the pad power rail (e.g., MX>CX>PX).

Aspects of the present disclosure overcome this issue by adding a signal, referred to as power on checker (POC), into the pad. The power on checker signal removes the dependency on the input power domain, e.g., the memory power rail (MX) and the core logic power rail (CX). With the power on checker signal, the pads are powered even when core logic and memory power rails (e.g., CX and MX) of the SoC are down. The POC signal disables both an input receiver of the I/O pads and an output buffer of the I/O pads, thereby protecting the pads. A lower power (e.g., 1.2 volts (V)) general purpose power rail (e.g., PX_14) generates the power on checker signal. Thus, there is no dependency on the reset signal from the power management integrated circuit (PMIC), RESIN_N, which is directed to the SoC.

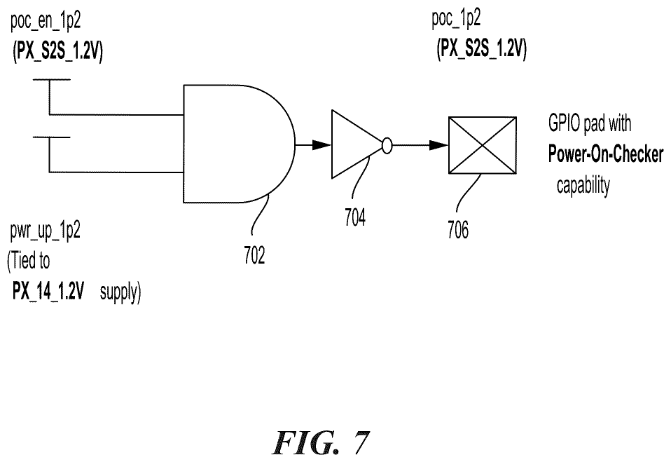

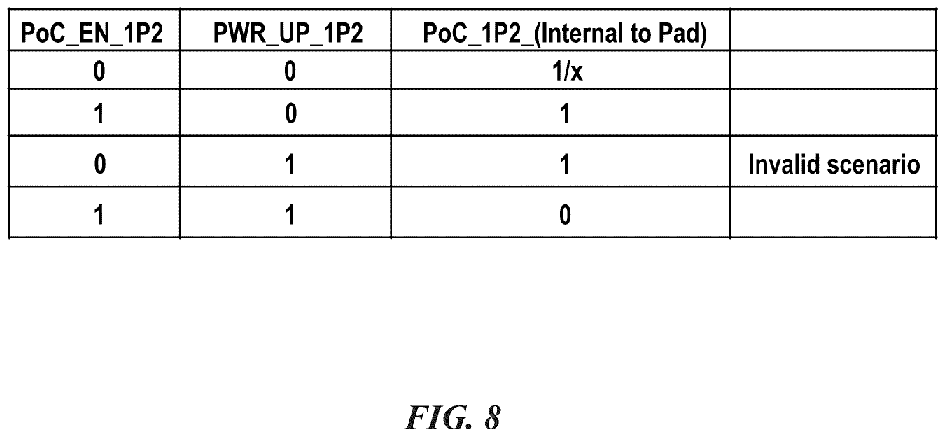

FIG. 7 is a circuit diagram illustrating power on checker (POC) logic, in accordance with various aspects of the present disclosure. FIG. 8 is a truth table for the power on checker (POC) logic of FIG. 7, in accordance with various aspects of the present disclosure. As seen in the example of FIG. 7, a logical AND gate 702 receives a power checker enable signal (poc_en_1p2) from a power supply (e.g., a 1.2 V power management integrated circuit (PMIC)). The power checker enable signal correspond to a 1.2 V pad power supply (PX_S2S_1.2V), which is always ON for SoC to SoC signals. The AND gate 702 also receives a power supply signal (pwr_up_1p2) that indicates whether the SoC is ON or OFF. The power supply signal is associated with the general purpose lower voltage (e.g., 1.2 V) rail (PX_14_1.2Vsupply). The output of the AND gate 702 is inverted with an inverter 704 and fed to an I/O pad 706 with power on checker capability.

The signal received at the I/O pad 706 based on the inputs to the AND gate 702 is shown in the truth table of FIG. 8 where a low power checker enable signal and a low power supply signal (e.g., the slave SoC is OFF) result in a 1/x power on checker signal (PoC_1P2) inside the I/O pad 706. If both inputs of the AND gate 702 are logical low then the output will be “1,” but if the battery is disconnected then the output will be an indeterministic state, referred to as “x”. Practically, this state is an invalid state because the always on power (e.g., poc_en_1p2) will always be present if the battery is connected to the system.

A high power checker enable signal and a low power supply signal (e.g., the slave SoC is OFF) result in a high power on checker signal (PoC_1P2) inside the I/O pad 706. A high power checker enable signal and a high power supply signal (e.g., the slave SoC is ON) result in a high power on checker signal (PoC_1P2) inside the I/O pad 706 such that normal operation occurs and the I/O pad 706 can be used for SoC-to-SoC communications. It is noted that a low power checker enable signal and a high power supply signal is an invalid scenario.

This solution does not have any dependency on a reset state of the SoC or reset assertion to the SoC. Hence, this solution enables scenarios where the pads do not get tri-stated due to this new logic when reset is asserted. The pads are tri-stated only when there is no power to the SoC, as indicated by the general purpose lower voltage (e.g., 1.2 V) rail (PX_14_1.2Vsupply).

In some cases, the SoCs operate with dual voltage, supporting a lower voltage (e.g., 1.2 V) and a higher voltage (e.g., 1.8 V). In these scenarios, a voltage detection circuit that detects the pad supply voltage is modified as the core logic power rail (CX) and memory power rail (MX) are not present. Because the voltage detection circuit would have issues without the CX/MX power rails, the voltage detection circuit comparator input may be set to originate from a 1.2V general purpose input/output (GPIO) digital input. Such a modification specifies one additional ball grid array (BGA) for each always on group. In other aspects, the pad voltage for these pads may be restricted to 1.8V. If the specifications of the product do not require 1.2V GPIO pads, the pads can be restricted to 1.8V, thus saving a pad for comparator input. In these implementations where there is no support for 1.2V for SoC to SoC signals, only 1.8V may be specified. Thus, voltage detection logic may be tied to 1.8V internally, saving two ball grid arrays (BGAs) in the IC package.

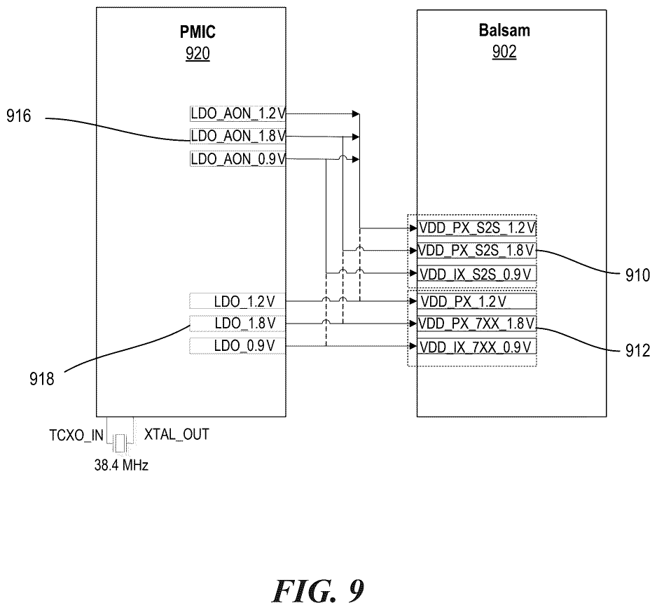

System level details of the solution will now be described with respect to FIG. 9. FIG. 9 is a block diagram illustrating multiple I/O pad groups and power sources, in accordance with various aspects of the present disclosure. In the example of FIG. 9, the I/O pads for an SoC 902 include a dedicated I/O pad group 910 that is separate from a general purpose input/output (GPIO) pad group 912. The dedicated I/O pad group 910 may be designated for interfacing between two SoCs. The dedicated I/O pad group 910 may be powered by an always on power domain 916 of a PMIC 920 in some configurations, such as a multi-SoC configuration. The dedicated I/O pad group 910 may be powered from a non-always on power domain 918 as part of a regular power on sequence in other configurations. For example, in a single SoC scenario, when there is no other SoC to back power these pads, the dedicated I/O pad group 910 need not be sourced by the always on power domain 916. Thus, current leakage is reduced. The non-always on power domain 918 also powers the GPIO pad group 912. The dashed lines in FIG. 9 indicate that the dedicated I/O pad group 910 may be sourced by either the always on power domain 916 or the non-always on power domain 918.

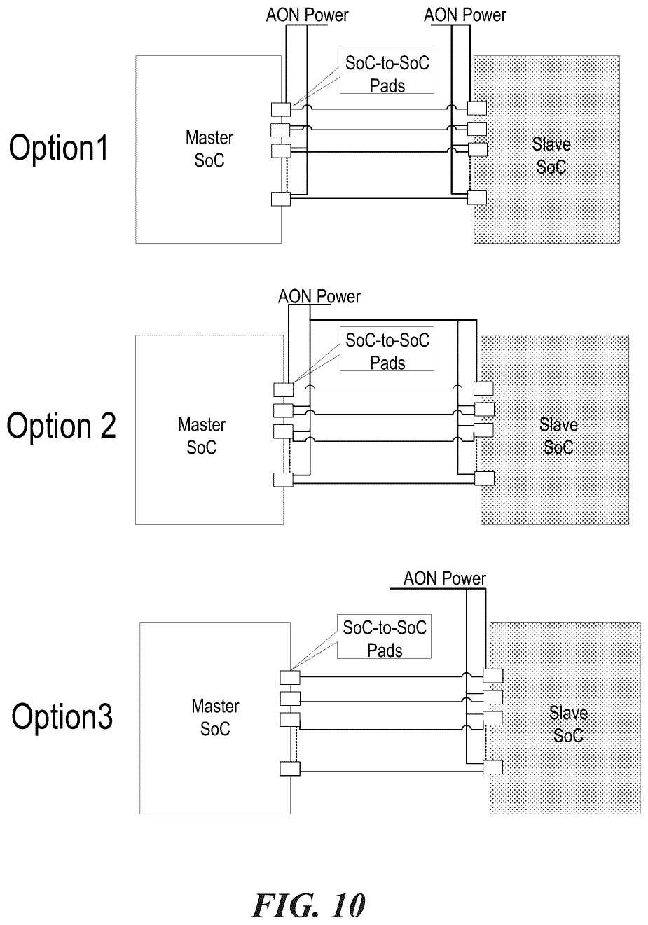

FIG. 10 is a block diagram illustrating different options for powering always on I/O pads, in accordance with various aspects of the present disclosure. Any of the three options illustrated in FIG. 10 may be implemented.

Currently, the same I/O supply cannot be shared between a master SoC and a slave SoC as they have their own power on sequence. According to aspects of the present disclosure, sharing is permissible.

In a first option (Option 1), master and slave SoCs each have their own PMIC with independent always on (AON) power supplies. When the master SoC is ON and the slave SoC is OFF, the slave SoC is protected by the always on power supply in the slave PMIC, and vice versa. In a second option (Option 2), the master always on power rail from the master PMIC is shared between the master and slave SoCs, reducing off leakage. This option is possible when the master SoC is never OFF while the slave SoC is ON. In a third option (Option 3), the master always on power rail is OFF when the slave SoC is OFF, also assuming the master SoC is never OFF. Similarly, (although not shown) the slave always on power rail would be OFF when the master SoC is OFF, assuming the slave SoC is never OFF. The third option further reduces leakage.

Aspects of the present disclosure reduce current leakage and save bill of material costs, while saving die area with the smaller pad size. These aspects have applications in any multi-chip system across segments like wearables, modems, compute devices, and internet-of-things (IOT) devices that use advanced technology nodes.

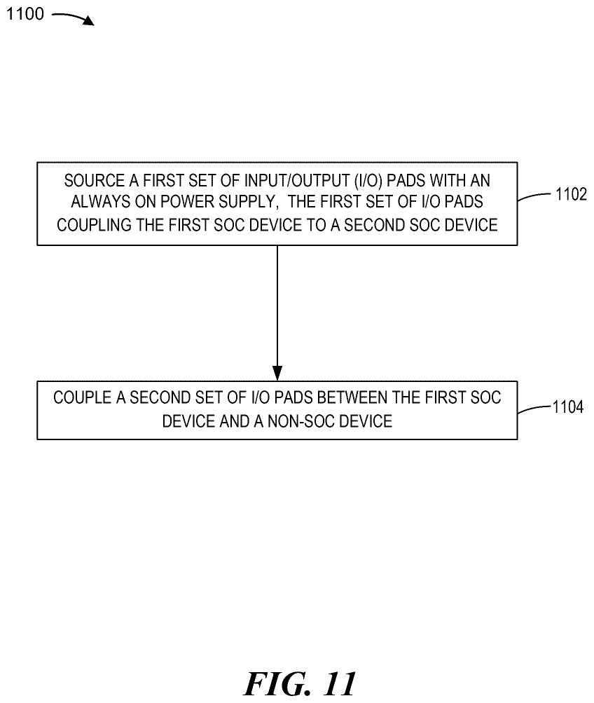

FIG. 11 is a flowchart illustrating operation of always on I/O pads, according to various aspects of the present disclosure. As shown in FIG. 11, in some aspects, the process 1100 may include sourcing a first number of input/output (I/O) pads with an always on power supply (block 1102). The first number of I/O pads couples the first SoC device to a second SoC device. The process 1100 may include coupling a second number of I/O pads between the first SoC device and a non-SoC device (block 1104).

### EXAMPLE ASPECTS

Aspect 1: A first system-on-a-chip (SoC) device, comprising: a first plurality of input/output (I/O) pads coupling the first SoC device to a second SoC device, the first plurality of I/O pads sourced with an always on power supply; and a second plurality of I/O pads coupling the first SoC device to a non-SoC device.
Aspect 2: The first SoC device of Aspect 1, in which the always on power supply is coupled to the first SoC device and the second SoC device.
Aspect 3: The first SoC device of Aspect 1, in which the always on power supply is coupled to the first SoC device and not to the second SoC device.
Aspect 4: The first SoC device of any of the preceding Aspects, further comprising a signal generator that generates a power on checker (POC) signal regardless of whether a memory power rail is off and regardless of whether a logic power rail is off.
Aspect 5: The first SoC device of any of the preceding Aspects, in which the power on checker signal disables input receivers of the first plurality of I/O pads and disables output buffers of the first plurality of I/O pads.
Aspect 6: The first SoC device of any of the preceding Aspects, further comprising a dual voltage comparator receiving input from a lower operating voltage general purpose input/output (GPIO) digital input, the first SoC device operating with both a lower operating voltage and a higher operating voltage.
Aspect 7: The first SoC device of any of the preceding Aspects, in which the first plurality of I/O pads is restricted to a higher operating voltage, the first SoC device operating with the higher operating voltage and not with a lower operating voltage.
Aspect 8: The first SoC device of any of the preceding Aspects, in which the first plurality of I/O pads are selectively sourced with the always on power supply in a multi-SoC configuration where SoC-to-SoC communications occur, and the first plurality of I/O pads are selectively sourced with a non-always on power supply in a single SoC configuration.
Aspect 9: A first system-on-a-chip (SoC) device, comprising: first means for coupling the first SoC device to a second SoC device, the first means for coupling the first SoC device to the second SoC device sourced with an always on power supply; and second means for coupling the first SoC device to a non-SoC device.
Aspect 10: The first SoC device of Aspect 9, in which the always on power supply is coupled to the first SoC device and the second SoC device.
Aspect 11: The first SoC device of Aspect 9, in which the always on power supply is coupled to the first SoC device and not to the second SoC device.
Aspect 12: The first SoC device of any of the Aspects 9-11, further comprising means for generating a power on checker (POC) signal regardless of whether a memory power rail is off and regardless of whether a logic power rail is off.
Aspect 13: The first SoC device of any of the Aspects 9-12, in which the power on checker signal disables input receivers of the first means for coupling the first SoC device to the second SoC device and disables output buffers of the means for coupling the first SoC device to a second SoC device.
Aspect 14: The first SoC device of any of the Aspects 9-13, further comprising means for receiving input from a lower operating voltage general purpose input/output (GPIO) digital input, the first SoC device operating with both a lower operating voltage and a higher operating voltage.
Aspect 15: The first SoC device of any of the Aspects 9-14, in which the first means for coupling the first SoC device to the second SoC device is restricted to a higher operating voltage, the first SoC device operating with the higher operating voltage and not with a lower operating voltage.
Aspect 16: The first SoC device of any of the Aspects 9-15, in which the first means for coupling the first SoC device to the second SoC device are selectively sourced with the always on power supply in a multi-SoC configuration where SoC-to-SoC communications occur, and the first means for coupling the first SoC device to the second SoC device are selectively sourced with a non-always on power supply in a single SoC configuration.
Aspect 17: A method of operating a first system-on-a-chip (SoC) device, comprising: sourcing a first plurality of input/output (I/O) pads with an always on power supply, the first plurality of I/O pads coupling the first SoC device to a second SoC device; and coupling a second plurality of I/O pads between the first SoC device and a non-SoC device.
Aspect 18: The method of Aspect 17, further generating a power on checker (POC) signal regardless of whether a memory power rail is off and regardless of whether a logic power rail is off.
Aspect 19 The method of Aspect 17 or 18, in which the power on checker signal disables input receivers of the first plurality of I/O pads and disables output buffers of the first plurality of I/O pads.
Aspect 20: The method of any of the Aspects 17-19, further comprising receiving input from a lower operating voltage general purpose input/output (GPIO) digital input, the first SoC device operating with both a lower operating voltage and a higher operating voltage.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A first system-on-a-chip (SoC) device, comprising:
a first plurality of input/output (I/O) pads coupling the first SoC device to a second SoC device, the first plurality of I/O pads sourced with an always on power supply; and
a second plurality of I/O pads coupling the first SoC device to a non-SoC device.

2. The first SoC device of claim 1, in which the always on power supply is coupled to the first SoC device and the second SoC device.

3. The first SoC device of claim 1, in which the always on power supply is coupled to the first SoC device and not to the second SoC device.

4. The first SoC device of claim 1, further comprising a signal generator that generates a power on checker (POC) signal regardless of whether a memory power rail is off and regardless of whether a logic power rail is off.

5. The first SoC device of claim 4, in which the power on checker signal disables input receivers of the first plurality of I/O pads and disables output buffers of the first plurality of I/O pads.

6. The first SoC device of claim 1, further comprising a dual voltage comparator receiving input from a lower operating voltage general purpose input/output (GPIO) digital input, the first SoC device operating with both a lower operating voltage and a higher operating voltage.

7. The first SoC device of claim 1, in which the first plurality of I/O pads is restricted to a higher operating voltage, the first SoC device operating with the higher operating voltage and not with a lower operating voltage.

8. The first SoC device of claim 1, in which the first plurality of I/O pads are selectively sourced with the always on power supply in a multi-SoC configuration where SoC-to-SoC communications occur, and the first plurality of I/O pads are selectively sourced with a non-always on power supply in a single SoC configuration.

9. A first system-on-a-chip (SoC) device, comprising:
first means for coupling the first SoC device to a second SoC device, the first means sourced with an always on power supply; and
second means for coupling the first SoC device to a non-SoC device.

10. The first SoC device of claim 9, in which the always on power supply is coupled to the first SoC device and the second SoC device.

11. The first SoC device of claim 9, in which the always on power supply is coupled to the first SoC device and not to the second SoC device.

12. The first SoC device of claim 9, further comprising means for generating a power on checker (POC) signal regardless of whether a memory power rail is off and regardless of whether a logic power rail is off.

13. The first SoC device of claim 12, in which the power on checker signal disables input receivers of the first means for coupling the first SoC device to the second SoC device and disables output buffers of the first means for coupling the first SoC device to the second SoC device.

14. The first SoC device of claim 9, further comprising means for receiving input from a lower operating voltage general purpose input/output (GPIO) digital input, the first SoC device operating with both a lower operating voltage and a higher operating voltage.

15. The first SoC device of claim 9, in which the first means for coupling the first SoC device to the second SoC device is restricted to a higher operating voltage, the first SoC device operating with the higher operating voltage and not with a lower operating voltage.

16. The first SoC device of claim 9, in which the first means for coupling the first SoC device to the second SoC device are selectively sourced with the always on power supply in a multi-SoC configuration where SoC-to-SoC communications occur, and the first means for coupling the first SoC device to the second SoC device are selectively sourced with a non-always on power supply in a single SoC configuration.

17. A method of operating a first system-on-a-chip (SoC) device, comprising:
sourcing a first plurality of input/output (I/O) pads with an always on power supply, the first plurality of I/O pads coupling the first SoC device to a second SoC device; and
coupling a second plurality of I/O pads between the first SoC device and a non-SoC device.

18. The method of claim 17, further generating a power on checker (POC) signal regardless of whether a memory power rail is off and regardless of whether a logic power rail is off.

19. The method of claim 18, in which the power on checker signal disables input receivers of the first plurality of I/O pads and disables output buffers of the first plurality of I/O pads.

20. The method of claim 17, further comprising receiving input from a lower operating voltage general purpose input/output (GPIO) digital input, the first SoC device operating with both a lower operating voltage and a higher operating voltage.
